(19) United States
(12) Patent Application Publication
(10) Pub. No.: US 2005/0253051 A1
(43) Pub. Date: Nov. 17, 2005

(54) Monitoring device for rotating body

(76) Inventors: Yoha Hwang, Seoul (KR); Sang Bae Lee, Seoul (KR); Jong Min Lee, Gwangmyeong-si (KR)

Correspondence Address: JONES DAY, 222 EAST 41ST ST, NEW YORK, NY, 10017, US

(21) Appl. No.: 11/022,017

(22) Filed: Dec. 23, 2004

(30) Foreign Application Priority Data
May 14, 2004 (KR) 10-2004-34252

(51) Int. Cl. G01J 5/08

(52) U.S. Cl. 250/227.18

(57) ABSTRACT

A fiber Bragg grating (FBG) sensor is mounted to a rotating body, which is supported by a rotating shaft mounted rotatably with respect to a fixed element. The FBG sensor extends along the rotating shaft, one end of which is disposed at the center of the end of the rotating shaft. An optical fiber is mounted to the fixed element, one end of which is disposed opposite to the end of the FBG sensor, apart from the FBG sensor. Light emitted from a broadband light source passes through the optical fiber and is transmitted to the FBG sensor across a gap between the optical fiber and the FBG sensor. The FBG sensor reflects light with frequencies corresponding to deformation of the rotating body. A data processing unit receives the reflected light and calculates the deformation of the rotating body based thereupon.

### FIELD OF THE INVENTION

The present invention relates to a monitoring device for a rotating body, and more particularly to a monitoring device which detects defects or breakdowns of a rotating body, such as a flywheel, a rotor of a helicopter, etc., by using a fiber Bragg grating sensor.

### BACKGROUND OF THE INVENTION

A rotating body is an important component of a mechanical apparatus, such as a flywheel of a flywheel energy storage system, a rotor of a helicopter, a turbine blade and so on. Therefore, it is very important to monitor the rotating body to detect any defects or breakdowns in order to prevent unexpected accidents. One method of monitoring the rotating body during operation is to mount sensors like strain-gauges directly to the rotating body. However, such method has a problem in that it is difficult to supply power to the sensors and to transmit signals from the sensors to a control portion, which is located away from the rotating body.

A slip ring, which is mounted to a rotating shaft supporting the rotating body, is used in the method of supplying power to the sensors and transmitting the signals to the control portion. Cables of the sensors are collected to the slip ring and connected thereto. However, a problem typically results as the contact between a rotor and a stator of the slip ring must be constant. Further, wear and noise usually occur due to such contact. Moreover, if the rotating body has a plurality of points to be monitored, such as a turbine, the installation and wiring of the slip ring become highly limited.

Another method of monitoring the rotating body is to mount a signal processing unit and a battery together with the sensors to the rotating body. However, the battery must be periodically replaced, which can be a hassle. Further, mounting the above monitoring equipment to the high-speed rotating body can be extremely difficult due to the weight and size of the equipment.

On the other hand, there is an indirect monitoring method of mounting the sensor to an interconnected component, which is located adjacent to the rotating body. For example, an accelerometer or a gap sensor that is mounted to a housing of a bearing, which supports the rotating body, can detect vibration of the rotating body. However, it is very difficult to show a link between the vibration signals and the indications of defect or breakdown of the rotating body, and to further detect the deformation of the rotating body, in an early step with the above indirect monitoring method.

### SUMMARY OF THE INVENTION

It is an object of the present invention to overcome the problems of the prior art and provide a monitoring device for a rotating body, which can accurately detect defects or breakdowns of the rotating body during operation and which can be easily installed.

Consistent with the foregoing object, and in accordance with the invention as embodied broadly herein, there is provided a monitoring device for a rotating body, which is supported by a rotating shaft that is mounted rotatably with respect to a fixed element. The monitoring device comprises: a broadband light source for emitting light; a light-transmitting means, which is connected to the broadband light source and mounted to the fixed element; a fiber Bragg grating sensor, which is mounted to the rotating body, the fiber Bragg grating sensor receiving the light from the broadband light source via the light-transmitting means and reflecting light with frequencies corresponding to deformation of the rotating body; and a data processing unit, which is connected to the light-transmitting means, the data processing unit receiving the light reflected from the fiber Bragg grating sensor via the light-transmitting means and calculating the deformation of the rotating body based upon the reflected light.

The fiber Bragg grating sensor extends along the rotating shaft and one end of the fiber Bragg grating sensor is disposed at the center of the end of the rotating shaft. In addition, the light-transmitting means is an optical fiber, one end of which is disposed opposite to the end of the fiber Bragg grating sensor.

### BRIEF DESCRIPTION OF DRAWINGS

The above object and features of the present invention will become more apparent from the following description of the preferred embodiments given in conjunction with the accompanying drawings.

FIG. 1 schematically shows a flywheel to which a monitoring device for a rotating body, which is constructed in accordance with a preferred embodiment of the present invention, is installed.

FIGS. 2a to 2d show variable modifications of mounting a fiber Bragg grating sensor to a rotating shaft of the flywheel.

FIG. 3 schematically shows a helicopter in which a monitoring device for a rotating body, which is constructed in accordance with a preferred embodiment of the present invention, is installed to a rotor.

FIG. 4 is a partial sectional view showing the mounting structure of a fiber Bragg grating sensor and the rotor illustrated in FIG. 3.

### DETAILED DESCRIPTION OF THE PRESENT INVENTION

Preferred embodiments of the present invention will now be described with reference to the accompanying drawings.

FIG. 1 schematically shows a flywheel of a flywheel energy storage system to which a monitoring device for a rotating body, which is constructed in accordance with a preferred embodiment of the present invention, is installed.

As shown in the drawing, rotating shafts 12 are coupled to the central portions of the both ends of a cylindrical flywheel 10. The rotating shafts 12 rotate together with the flywheel 10 while being supported by bearings 28. In order to monitor the flywheel 10 in real time during the rotation, a fiber Bragg grating (FBG) sensor 20 is wound around the flywheel 10 in a spiral shape.

As already known, the FBG sensor 20 has an optical fiber 22 and a plurality of Bragg gratings 24, which are formed at the optical fiber 22. When light passes through the FBG sensor 20, each of the Bragg gratings 24 reflects the light that has the frequency satisfying its own Bragg condition, but allows the light having other frequency to pass through. Generally, the frequency satisfying the Bragg condition is called a Bragg frequency. If an ambient temperature of the FBG sensor 20 varies and a tensional or compressional force is applied to the FBG sensor 20, the refractive index or the length of the optical fiber 22 is changed. Thus, the Bragg frequency is also changed. As reported, 1% tension of the optical fiber 22 results in about 12 nm variation of the Bragg frequency's wavelength, 1% compression of the optical fiber 22 results in about 32 nm variation of the Bragg frequency's wavelength, and 100° C. temperature variation results in about 1.1 nm variation of the Bragg frequency's wavelength. Accordingly, the ambient temperature, tension, compression or bending can be detected by measuring the frequencies of the light, which is reflected from the Bragg gratings 24 of the FBG sensor 20.

The optical fiber 22 (hereinafter, it will be referred to as a first optical fiber) of the FBG sensor 20 is attached to a circumference of the flywheel 10 (in a spiral shape) by means of an epoxy resin, etc. The optical fiber 22 is fittingly inserted into a through-hole 14, which is formed axially throughout the rotating shaft 12 at its central portion. One end of the optical fiber 22 is disposed at the center of the end of the rotating shaft 12. Conventionally, the optical fiber 22 is too thin and light to affect the rotation of the flywheel 10 and the rotating shaft 12. Further, a balancing process may be performed after attaching the FBG sensor 20 to the flywheel 10. On the other hand, the FBG sensor 20 may be placed inside the flywheel 10 when manufacturing the flywheel 10.

An element 30, which is fixedly mounted opposite to the rotating shaft 12 and placed apart therefrom in the flywheel energy storage system, is provided with a light-transmitting means (i.e., a second optical fiber 32). The end of the second optical fiber 32 is aligned with the end of the first optical fiber 22. The second optical fiber 32 extends outward of the flywheel energy storage system and is connected to a data processing unit 40 for calculating the deformation of the flywheel 10. The reason for installing the second optical fiber 32 to the fixed element 30 in the system, apart from the first optical fiber 22, is that the first optical fiber 22 rotates together with the flywheel 10 and the rotating shaft 12. Thus, it cannot be connected directly to the data processing unit 40. Also, such an arrangement of the first and second optical fibers 22 and 32 is available because a typical optical fiber has a feature that it can transmit and receive light signals to and from the other optical fiber, which is disposed apart therefrom.

The data processing unit 40 comprises: a broadband light source (not shown) for emitting light at a wide frequency range, to which the second optical fiber 32 is connected; a light-receiving means (not shown) for receiving the light reflected from the FBG sensor 20 and converting the received light into electric signals; an optical coupler (not shown) which is connected to the second optical fiber 32 for passing the light from the broadband light source through the second optical fiber 32 and for passing the light reflected from the FBG sensor 20 toward the light-receiving means; and an analyzing portion (not shown) for receiving the signals from the light-receiving means and analyzing the signals to calculate the deformation of the flywheel 10. Since the structure and deformation detecting process of the data processing unit 40 are well known to a person skilled in the art, the explanation thereof is omitted herein.

On the other hand, the misalignment of two opposed ends of the first and second optical fibers 22 and 32 may occur by vibration due to the rotation of the rotating shaft 12, thereby causing the signal transmission to be interrupted. In order to prevent this problem, collimating and focusing means 26 are mounted to two opposed ends of the first and second optical fibers 22 and 32. The collimating and focusing means 26 may be embodied in a gradient-index (GRIN) rod lens or a C-lens. Since these lenses are well known to a person skilled in the art of optics, the description thereof is omitted herein.

Hereinafter, the operational effect of the monitoring device for a rotating body according to the present invention will be described.

The light emitted from the broadband light source in the data processing unit 40 passes through the second optical fiber 32 and is transformed parallel via the collimating and focusing means 26 mounted at the fixed element 30. Then, the parallel light progresses from the fixed element 30 toward the rotating shaft 12 across the gap therebetween. The parallel light is focused on the end of the first optical fiber 22 of the FBG sensor 20 via the collimating and focusing means 26 mounted at the rotating shaft 12 and passes through the first optical fiber 22.

The light having the frequencies satisfying the above-described Bragg conditions is reflected from the Bragg gratings 24. However, the light having other frequencies passes through the Bragg gratings 24. If the flywheel 10 is deformed, the Bragg gratings 24 are also deformed. This causes the frequencies of light, which can be reflected from the Bragg gratings 24, to be varied corresponding to the deformation of the Bragg gratings 24. The light reflected from the Bragg gratings 24 passes through the first optical fiber 22 and is transformed into parallel via the collimating and focusing means 26 mounted at the rotating shaft 12. The parallel light progresses toward the fixed element 30 across the gap between the rotating shaft 12 and the fixed element 30. The parallel light is focused on the second optical fiber 32 via the collimating and focusing means 26 mounted at the fixed element 30 and transmitted to the light-receiving means in the data processing unit 40 through the second optical fiber 32. The light-receiving means converts the received light into electric signals and transfers the signals to the analyzing portion. The analyzing portion calculates the deformation of the flywheel 10 based upon the signals.

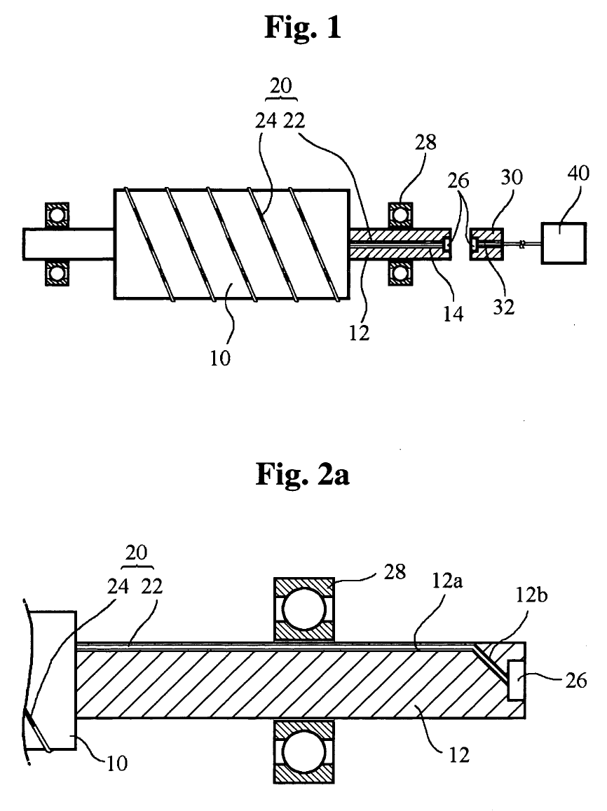

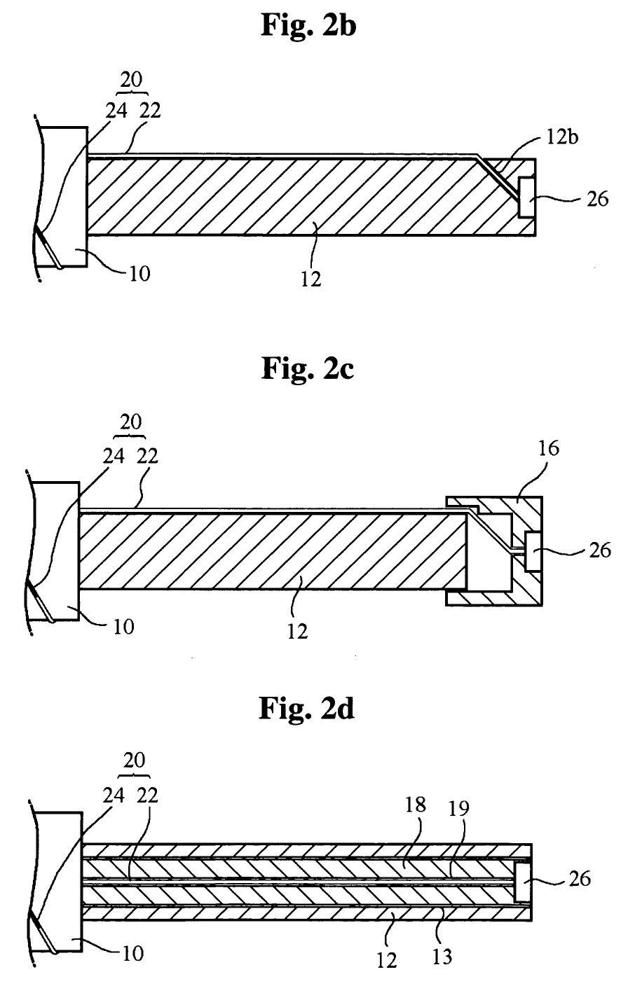

FIGS. 2a to 2d illustrates variable modifications of mounting the FBG sensor 20 to the rotating shaft 12 of the flywheel 10.

In the above-described embodiment (with reference to FIG. 1), the first optical fiber 22 is inserted into the through-hole 14 that is formed at the central portion of the rotating shaft 12 along its central axis. However, when the rotating shaft 12 is relatively long, it is so difficult to form the through-hole 14 axially throughout the rotating shaft 12 at its central portion, into which the first optical fiber 22 is fittingly inserted. In this case, as shown in FIG. 2a, a slot 12a is formed axially at the outer surface of the rotating shaft 12 from a point in conjunction with the flywheel 10 to a point adjacent to the end of the rotating shaft 12. Further, a guide hole 12b is formed to communicate with the end of the slot 12a and extend toward the collimating and focusing means 26 mounted at the end of the rotating shaft 12. Therefore, the first optical fiber 22 of the FBG sensor 20 adhered to the flywheel 10 extends along the rotating shaft 12 while being bonded or fitted in the slot 12a. It is then inserted into the guide hole 12b. The slot 12a prevents the interference between the first optical fiber 22 and the bearing 28, thus ensuring the smooth rotation of the shaft 12.

As shown in FIG. 2b, if the rotating shaft 12 is not supported by any bearing, only the guide hole 12b is formed, which extends from a circumferential point adjacent to the end of the rotating shaft 12 to the collimating and focusing means 26, without forming the slot 12a (see FIG. 2a). Therefore, the first optical fiber 22 of the FBG sensor 20 adhered to the flywheel 10 extends along the rotating shaft 12 while being bonded on the outer surface of the rotating shaft 12. It is then inserted into the guide hole 12b.

If the slot 12a or the guide hole 12b cannot be formed at the rotating shaft 12, then an additional accommodating member 16 equipped with the collimating and focusing means 26 at its central portion may be coupled to the end of the rotating shaft 12 (as shown in FIG. 2c). The first optical fiber 22 of the FBG sensor 20 adhered to the flywheel 10 extends along the rotating shaft 12 while being bonded on the outer surface of the rotating shaft 12. It is then guided into the accommodating member 16 toward the collimating and focusing means 26.

On the other hand, if the rotating shaft 12 is too long and supported by bearings, the first optical fiber 22 should pass through the rotating shaft 12 axially. But, it is very difficult or even impossible to form a narrow path (into which an optical fiber is fittingly inserted) axially inside the rotating shaft 12, the physical property of which is mostly hard and rigid. In order to solve this problem, there is provided a supporting rod 18 (as shown in FIG. 2d). The supporting rod 18 is made from a soft material, such as a plastic, so as to form an optical fiber path 19 axially therein with facility. The supporting rod 18 is equipped with the collimating and focusing means 26 at its end. Further, an insertion hole 13 (into which the supporting rod 18 is fittingly inserted) is formed axially throughout the rotating shaft 12 at its central portion. As a result, the installation or maintenance of the first optical fiber 22 can be achieved with ease by separating and inserting the supporting rod 18 from and into the insertion hole 13 of the rotating shaft 12.

It is not necessary to form the optical fiber path 19 at the central portion of the supporting rod 18. Instead, a slot may be formed axially on the outer surface of the supporting rod 18, in which the first optical fiber 22 is bonded or fitted. In this case, the additional accommodating member 16 (see FIG. 2c) should be coupled at the end of the rotating shaft 12.

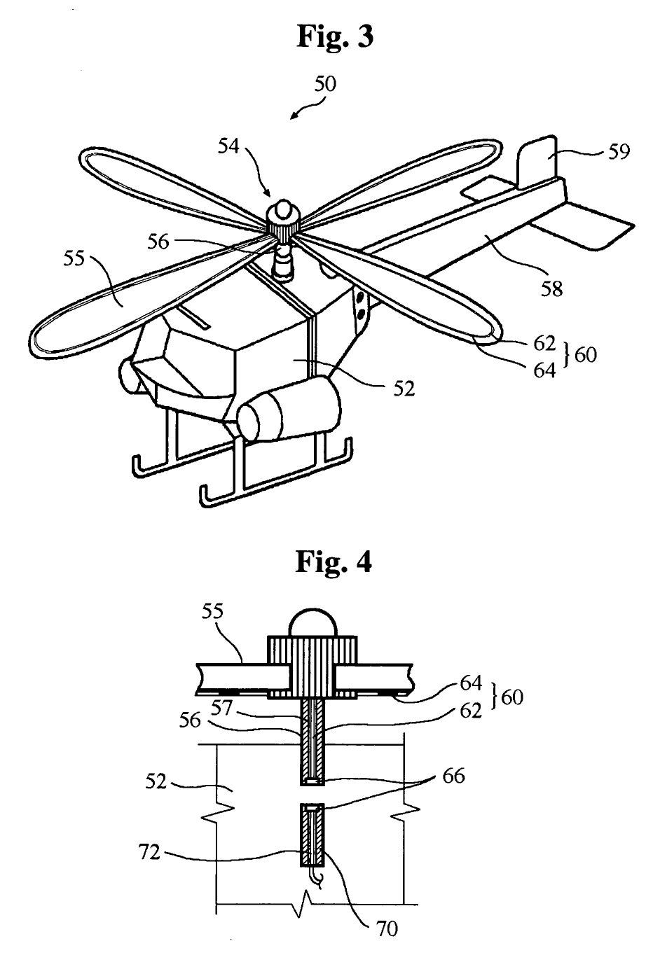

FIG. 3 schematically shows a helicopter, in which a monitoring device for a rotating body of the present invention is installed to rotor blades. FIG. 4 is a partial sectional view showing the mounting structure of a FBG sensor and the rotor illustrated in FIG. 3.

As shown in the drawings, a helicopter 50 generally comprises a body 52, a rotor 54 which is connected to the body 52 by means of a rotating shaft 56, a tail boom 58, and a tail blade 59. The rotor 54 typically has three or four blades 55.

An optical fiber 62 of a FBG sensor 60 is adhered to the surfaces of all blades 55 and passes through the rotating shaft 56 axially. An insertion hole 57 is formed axially throughout the rotating shaft 56 at its central portion (into which the optical fiber 62 is fittingly inserted) so that one end of the optical fiber 62 is disposed at the center of the end of the rotating shaft 56. The FBG sensor 60 may be placed inside the blades 55 when manufacturing the blades 55. As described above with reference to FIGS. 2a to 2d, the mounting structure of the optical fiber 62 and the rotating shaft 56 can be modified diversely.

An element 70, which is fixedly mounted opposite to the rotating shaft 56 and disposed apart therefrom in the body 52 of the helicopter, is provided with another optical fiber 72. The end of the optical fiber 72 is aligned with the end of the optical fiber 62 of the FBG sensor 60. The optical fiber 72 is connected to a data processing unit (not shown) for calculating the deformation of the blades 55.

In order to detect defects or breakdowns of each of the blades 55, Bragg gratings 64 are independently formed at the optical fiber 62 at the respective blades 55, so that the frequencies of light which is reflected from the Bragg gratings 64 at one blade 55 are different from the frequencies of light which is reflected from the Bragg gratings 64 at the other blade 55.

Collimating and focusing means 66 are mounted to two opposed ends of the rotating shaft 56 and the fixed element 70. The collimating and focusing means 66 may be embodied in a GRIN rod lens or a C-lens.

Since the operation and effect of this embodiment are same as those of the previous embodiment (the flywheel energy storage system), the explanation thereof is omitted herein.

As described above in detail, a monitoring device for a rotating body according to the present invention is configured to accurately detect defects or breakdowns of a rotating body during operation by adhering a FBG sensor to a rotating body, and by further installing another optical fiber to any fixed element for transmitting and receiving light to and from the FBG sensor.

Further, since the FBG sensor is too thin and light to affect the rotation of the rotating body, the installation process is simple and the operational reliability is enhanced.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes, which come within the equivalent meaning and range of the claims, are to be embraced within their scope.

1. A monitoring device for a rotating body supported by a rotating shaft mounted rotatably with respect to a fixed element, comprising:
a broadband light source for emitting light;
a light-transmitting means connected to the broadband light source and mounted to the fixed element;
a fiber Bragg grating sensor mounted to the rotating body, the fiber Bragg grating sensor receiving the light from the broadband light source via the light-transmitting means and reflecting light with frequencies corresponding to deformation of the rotating body; and
a data processing unit connected to the light-transmitting means, the data processing unit receiving the light reflected from the fiber Bragg grating sensor via the light-transmitting means and calculating the deformation of the rotating body based upon the reflected light.

2. The monitoring device of claim 1, wherein the fiber Bragg grating sensor extends along the rotating shaft and one end of the fiber Bragg grating sensor is disposed at the center of the end of the rotating shaft; and
the light-transmitting means is an optical fiber, one end of which is disposed opposite to the end of the fiber Bragg grating sensor.

3. The monitoring device of claim 2, wherein an insertion hole is formed axially throughout the rotating shaft at the central portion, into which the fiber Bragg grating sensor is inserted.

4. The monitoring device of claim 2, wherein a slot is formed axially at the outer surface of the rotating shaft, in which the fiber Bragg grating sensor is fitted; and
a guide hole is formed at the rotating shaft, the guide hole communicating with the end of the slot and extending toward the center of the end of the rotating shaft, into which the fiber Bragg grating sensor is inserted.

5. The monitoring device of claim 2, wherein a guide hole is formed at the rotating shaft, the guide hole communicating with a circumferential point adjacent to the end of the rotating shaft and extending toward the center of the end of the rotating shaft, into which the fiber Bragg grating sensor is inserted.

6. The monitoring device of claim 2, wherein the monitoring device further comprises a supporting rod having a path formed axially, through which the fiber Bragg grating sensor passes; and
an insertion hole, into which the supporting rod is inserted, is formed axially throughout the rotating shaft at the central portion.

7. The monitoring device of claim 2, wherein the monitoring device further comprises an accommodating member, which is coupled to the end of the rotating shaft, the accommodating member guiding the fiber Bragg grating sensor thereinto so that the end of the fiber Bragg grating sensor is positioned at the center of the rotating shaft.

8. The monitoring device of any one of claims 2-7, wherein the monitoring device further comprises collimating and focusing means provided at two opposed ends of the fiber Bragg grating sensor and the optical fiber.
